(19) United States
(12) Patent Application Publication
(10) Pub. No.: US 2026/0310157 A1
(43) Pub. Date: Oct. 8, 2026

(54) System, Method, Electronic Device, and Medium for Controlling Servo System

(71) Applicant: Siemens Aktiengesellschaft, München (DE)

(72) Inventors: Chuan Tian, Nanjing, JS (CN); Jian Yuan Wu, Nanjing, JS (CN); Chong Xing Zheng, Nanjing, JS (CN); Jun Li Ji, Nanjing, JS (CN); Ming Liu, Nanjing, JS (CN); Lei Cui, Nanjing, JS (CN)

(73) Assignee: Siemens Aktiengesellschaft, München (DE)

(21) Appl. No.: 19/481,270

(22) PCT Filed: May 6, 2023
(86) PCT No.: PCT/CN2023/092476

§ 371 Date: Nov. 4, 2025

(51) Int. Cl. G05B 19/19

(52) U.S. Cl. CPC G05B 19/19; G05B 2219/41068; G05B 2219/41374; G05B 2219/42064; G05B 2219/42342

(57) ABSTRACT

Various embodiments include systems for controlling a servo system. An example includes: a reference trajectory generator to generate reference trajectory signal of servo system based on manufacturing task instruction, terminal state prediction signal within a sliding window of the servo system, measurement signal of the servo system, and disturbance estimation signal of the servo system; a controller to generate control signal for controlling the servo system and update the disturbance estimation signal based on the reference trajectory signal and the measurement signal; and a predictor to update the terminal state prediction signal based on the reference trajectory signal, the control signal, and the measurement signal updated due to the execution of the control signal by the servo system. The reference trajectory generator updates the reference trajectory signal based on the manufacturing task instruction, updated terminal state prediction signal, updated measurement signal, and updated disturbance estimation signal.

### CROSS-REFERENCE TO RELATED APPLICATIONS

This application is a U.S. National Stage Application of International Application No. PCT/CN2023/092476 filed May 6, 2023, which designates the United States of America, the contents of which are hereby incorporated by reference in their entirety.

### TECHNICAL FIELD

The present disclosure relates to servo control technology. Various embodiments include systems, methods, electronic devices, and media for controlling servo system.

### BACKGROUND

Computer Numerical Control (CNC) servo system is an automatic control system that directly controls mechanical displacement, also known as position servo system, abbreviated as servo system. The servo system of CNC machine tools mainly includes: (1) feed servo system, which controls the cutting feed motion of each coordinate axis of the machine tool, mainly in linear motion; (2) Spindle servo system, which controls the cutting motion of the spindle and mainly revolves. The control methods of servo systems mainly include open loop, closed loop, and semi closed loop, etc.

Multi-axis CNC machines are important systems for manufacturing complex industrial products, where the trajectory planning strategy and the multi-DOF servo control design are key factors affecting the manufacturing performance. When Multi-axis CNC machines conduct various tasks and facing different working conditions, nonlinear dynamics, multi axis coupling, sampling quantization effect and uncertainties existed in the servo system may deteriorate the control and manufacturing performance with conventional digital linear time invariant (LTI) controllers such as PID controllers.

### SUMMARY

Various embodiments of the teachings of the present disclosure include systems, methods, electronic devices, and media for controlling servo systems. For example, some embodiments of the teachings herein include a system for controlling servo system, comprising: a reference trajectory generator (11), configured to generate reference trajectory signal of servo system (14) based on manufacturing task instruction for the servo system (14), terminal state prediction signal within a sliding window of the servo system (14), measurement signal of the servo system (14), and disturbance estimation signal of the servo system (14); a controller (12), configured to generate control signal for controlling the servo system (14) and update the disturbance estimation signal based on the reference trajectory signal and the measurement signal; and a predictor (13), configured to update the terminal state prediction signal based on the reference trajectory signal, the control signal, and the measurement signal updated due to the execution of the control signal by the servo system (14); wherein the reference trajectory generator (11) is configured to update the reference trajectory signal based on the manufacturing task instruction, updated terminal state prediction signal, updated measurement signal, and updated disturbance estimation signal.

In some embodiments, the system includes a manufacturing task generator (15), configured to generate the manufacturing task instruction based on user input.

In some embodiments, the controller (12) comprises: an anti-aliasing filter (125), configured to perform anti-aliasing filtering on the measurement signal; a sampler (126), configured to perform sampling on anti-aliasing filtered measurement signal to obtain discrete measurement signal; and an up-sampling processing module (127), configured to perform up-sampling processing on the discrete measurement signal.

In some embodiments, the controller (12) comprises a digital disturbance observer (128), configured to determine the disturbance estimation signal of the servo system (14) based on discrete measurement signal after the up-sampling processing and continuous control signal of the servo system (14); the continuous control signal is obtained by performing hold processing on a discrete control signal, which is obtained based on discrete MPC control signal and compensation value of the disturbance estimation signal, and the discrete MPC control signal is obtained based on the reference trajectory signal and the discrete measurement signal after the up-sampling processing.

In some embodiments, the controller (12) comprises: a disturbance analyzer (130), configured to determine disturbance feature information based on the disturbance estimation signal; a disturbance resampling module (129), configured to perform resampling on the disturbance estimation signal based on the disturbance feature information; and a disturbance compensator (131), configured to determine the compensation value of the disturbance estimation signal based on the resampled disturbance estimation signal.

In some embodiments, the controller (12) comprises: a digital model predictive controller (120), configured to determine the discrete MPC control signal based on the reference trajectory signal and the discrete measurement signal after the up-sampling processing; a subtractor (121), configured to subtract the compensation value of the disturbance estimation signal from the discrete MPC control signal to obtain the discrete control signal; and a holder (122), configured to hold the discrete control signal to generate the continuous control signal.

In some embodiments, the disturbance resampling module (129) is configured to determine disturbance indicator based on the disturbance feature information, wherein the resampling is performed on the disturbance estimation signal by increasing sampling frequency when the disturbance indicator is greater than a predetermined threshold value, and the resampling is performed on the disturbance estimation signal by reducing sampling frequency when the disturbance index is less than the threshold value.

As another example, some embodiments include a method for controlling servo system, comprising: generating (601) reference trajectory signal of servo system based on manufacturing task instruction for the servo system, terminal state prediction signal within a sliding window of the servo system, measurement signal of the servo system, and disturbance estimation signal of the servo system; generating (602) control signal for controlling the servo system based on the reference trajectory signal and the measurement signal; updating (603) the disturbance estimation signal based on the reference trajectory signal and the measurement signal; updating (604) the terminal state prediction signal based on the reference trajectory signal, the control signal, and the measurement signal updated due to the execution of the control signal by the servo system; and updating (605) the reference trajectory signal based on the manufacturing task instruction, updated terminal state prediction signal, updated measurement signal, and updated disturbance estimation signal.

In some embodiments, the method includes generating the manufacturing task instruction based on user input.

In some embodiments, the method includes: performing anti-aliasing filtering on the measurement signal; performing sampling on anti-aliasing filtered measurement signal to obtain discrete measurement signal; and performing up-sampling processing on the discrete measurement signal.

In some embodiments, the method includes determining the disturbance estimation signal of the servo system based on discrete measurement signal after the up-sampling processing and continuous control signal of the servo system; wherein the continuous control signal is obtained by performing hold processing on a discrete control signal, which is obtained based on discrete MPC control signal and compensation value of the disturbance estimation signal, and the discrete MPC control signal is obtained based on the reference trajectory signal and the discrete measurement signal after the up-sampling processing.

In some embodiments, the method includes: determining disturbance feature information based on the disturbance estimation signal; performing resampling on the disturbance estimation signal based on the disturbance feature information; and determining the compensation value of the disturbance estimation signal based on the resampled disturbance estimation signal.

In some embodiments, the method includes: determining the discrete MPC control signal based on the reference trajectory signal and the discrete measurement signal after the up-sampling processing; subtracting the compensation value of the disturbance estimation signal from the discrete MPC control signal to obtain the discrete control signal; and holding the discrete control signal to generate the continuous control signal.

In some embodiments, the method includes determining disturbance indicator based on the disturbance feature information; wherein the resampling is performed on the disturbance estimation signal by increasing sampling frequency when the disturbance indicator is greater than a predetermined threshold value, and the resampling is performed on the disturbance estimation signal by reducing sampling frequency when the disturbance index is less than the threshold value.

As another example, some embodiments include an electronic device, comprising a processor (701) and a memory (702), wherein an application program executable by the processor (701) is stored in the memory (702) for causing the processor (701) to execute one or more of the methods for controlling servo systems described herein.

As another example, some embodiments include a computer-readable medium comprising computer-readable instructions stored thereon, wherein the computer-readable instructions for executing one or more of the methods for controlling servo system described herein.

As another example, some embodiments include a computer program product comprising a computer program, upon the computer program is executed by a processor for executing one or more of the methods for controlling servo systems described herein.

### BRIEF DESCRIPTION OF THE DRAWINGS

In order to make technical solutions of examples of the present disclosure clearer, accompanying drawings to be used in description of the examples will be simply introduced hereinafter. Obviously, the accompanying drawings to be described hereinafter are only some examples of the teachings of the present disclosure. Those skilled in the art may obtain other drawings according to these accompanying drawings without creative labor.

FIG. 1 is a structural diagram of an example system for controlling a servo system incorporating teachings of the present disclosure;

FIG. 2 is an exemplary functional module diagram of an example controller incorporating teachings of the present disclosure;

FIG. 3 is a structural diagram of control system of an example multi axis servo system incorporating teachings of the present disclosure;

FIG. 4 is a schematic diagram of processing the measurement noise problem in a multi rate sampling framework incorporating teachings of the present disclosure;

FIG. 5 is a schematic diagram of disturbance analysis and sampling strategy incorporating teachings of the present disclosure;

FIG. 6 is a flowchart of an example method for controlling a servo system incorporating teachings of the present disclosure; and

FIG. 7 is a structural diagram of an example electronic device incorporating teachings of the present disclosure.

### LIST OF REFERENCE NUMBERS

| reference | |
|---|---|
| numbers | meanings |
| 11 | reference trajectory generator |
| 12 | controller |
| 13 | predictor |
| 14 | servo system |
| 15 | manufacturing task generator |
| 120 | digital model predictive |
| | controller |
| 121 | subtractor |
| 122 | holder |
| 123 | servo actuator |
| 124 | sensor |
| 125 | anti-aliasing filter |
| 126 | sampler |
| 127 | up-sampling processing module |
| 128 | digital disturbance observer |
| 129 | disturbance resampling module |
| 130 | disturbance analyzer |
| 131 | disturbance compensator |
| 14i-14q | axis servo system |
| 501~510 | steps |
| 601~605 | steps |
| 700 | electronic device |
| 701 | processor |
| 702 | memory |

### DETAILED DESCRIPTION

Various embodiments of the teachings herein include a system for controlling a servo system comprising: a reference trajectory generator, configured to generate reference trajectory signal of servo system based on manufacturing task instruction for the servo system, terminal state prediction signal within a sliding window of the servo system, measurement signal of the servo system, and disturbance estimation signal of the servo system; a controller, configured to generate control signal for controlling the servo system and update the disturbance estimation signal based on the reference trajectory signal and the measurement signal; and a predictor, configured to update the terminal state prediction signal based on the reference trajectory signal, the control signal, and the measurement signal updated due to the execution of the control signal by the servo system; wherein the reference trajectory generator is configured to update the reference trajectory signal based on the manufacturing task instruction, updated terminal state prediction signal, updated measurement signal, and updated disturbance estimation signal. Using this system, considering disturbance estimation in reference trajectory planning potentially improves trajectory planning efficiency and servo control accuracy.

In some embodiments, the system comprises a manufacturing task generator, configured to generate the manufacturing task instruction based on user input. Therefore, manufacturing task instructions can be generated based on user input, improving control flexibility.

In some embodiments, the controller comprises: an anti-aliasing filter, configured to perform anti-aliasing filtering on the measurement signal; a sampler, configured to perform sampling on anti-aliasing filtered measurement signal to obtain discrete measurement signal; and an up-sampling processing module, configured to perform up-sampling processing on the discrete measurement signal. Therefore, by implementing anti-aliasing filtering and multi rate sampling and holding, considering the limited sampling frequency of system output, the suppression problem of high-frequency disturbances outside the Nyquist frequency can be solved or alleviated.

In some embodiments, the controller comprises a digital disturbance observer, configured to determine the disturbance estimation signal of the servo system based on discrete measurement signal after the up-sampling processing and continuous control signal of the servo system; the continuous control signal is obtained by performing hold processing on a discrete control signal, which is obtained based on discrete MPC control signal and compensation value of the disturbance estimation signal, and the discrete MPC control signal is obtained based on the reference trajectory signal and the discrete measurement signal after the up-sampling processing. Therefore, considering the impact of measurement noise or disturbance on the design of MPC under multi rate sampling and holding, the design accuracy is improved.

In some embodiments, the controller comprises: a disturbance analyzer, configured to determine disturbance feature information based on the disturbance estimation signal; a disturbance resampling module, configured to perform resampling on the disturbance estimation signal based on the disturbance feature information; and a disturbance compensator, configured to determine the compensation value of the disturbance estimation signal based on the resampled disturbance estimation signal. Therefore, a novel overall architecture of disturbance observer and compensator is proposed, where the resampling period of disturbance compensation can be automatically selected and set based on the characteristics of disturbance, thus improving design flexibility.

In some embodiments, the controller comprises: a digital model predictive controller, configured to determine the discrete MPC control signal based on the reference trajectory signal and the discrete measurement signal after the up-sampling processing; a subtractor, configured to subtract the compensation value of the disturbance estimation signal from the discrete MPC control signal to obtain the discrete control signal; a holder, configured to hold the discrete control signal to generate the continuous control signal. Therefore, closed-loop anti-disturbance control is achieved by compensating the predicted signal for disturbance.

In some embodiments, the disturbance resampling module is configured to determine disturbance indicator based on the disturbance feature information, wherein the resampling is performed on the disturbance estimation signal by increasing sampling frequency when the disturbance indicator is greater than a predetermined threshold value, and the resampling is performed on the disturbance estimation signal by reducing sampling frequency when the disturbance index is less than the threshold value. Therefore, the disturbance indicators determined based on disturbance feature information can flexibly select multiple types of resampling strategies.

Some embodiments include a method for controlling servo system comprising: generating reference trajectory signal of servo system based on manufacturing task instruction for the servo system, terminal state prediction signal within a sliding window of the servo system, measurement signal of the servo system, and disturbance estimation signal of the servo system; generating control signal for controlling the servo system based on the reference trajectory signal and the measurement signal; updating the disturbance estimation signal based on the reference trajectory signal and the measurement signal; updating the terminal state prediction signal based on the reference trajectory signal, the control signal, and the measurement signal updated due to the execution of the control signal by the servo system; and updating the reference trajectory signal based on the manufacturing task instruction, updated terminal state prediction signal, updated measurement signal, and updated disturbance estimation signal. Therefore, considering disturbance estimation in reference trajectory planning potentially improves trajectory planning efficiency and servo control accuracy.

In some embodiments, the method comprises generating the manufacturing task instruction based on user input. Therefore, manufacturing task instructions can be generated based on user input, improving control flexibility.

In some embodiments, the method comprises: performing anti-aliasing filtering on the measurement signal; performing sampling on anti-aliasing filtered measurement signal to obtain discrete measurement signal; and performing up-sampling processing on the discrete measurement signal. Therefore, by implementing anti-aliasing filtering and multi rate sampling and holding, considering the limited sampling frequency of system output, the suppression problem of high-frequency disturbances outside the Nyquist frequency can be solved or alleviated.

In some embodiments, the method comprises: determining the disturbance estimation signal of the servo system based on discrete measurement signal after the up-sampling processing and continuous control signal of the servo system; wherein the continuous control signal is obtained by performing hold processing on a discrete control signal, which is obtained based on discrete MPC control signal and compensation value of the disturbance estimation signal, and the discrete MPC control signal is obtained based on the reference trajectory signal and the discrete measurement signal after the up-sampling processing. Therefore, considering the impact of measurement noise or disturbance on the design of MPC under multi rate sampling and holding, the design accuracy is improved.

In some embodiments, the method comprises: determining disturbance feature information based on the disturbance estimation signal; performing resampling on the disturbance estimation signal based on the disturbance feature information; and determining the compensation value of the disturbance estimation signal based on the resampled disturbance estimation signal. Therefore, a novel overall architecture of disturbance observer and compensator is proposed, where the resampling period of disturbance compensation can be automatically selected and set based on the characteristics of disturbance, thus improving design flexibility.

In some embodiments, the method comprises: determining the discrete MPC control signal based on the reference trajectory signal and the discrete measurement signal after the up-sampling processing; subtracting the compensation value of the disturbance estimation signal from the discrete MPC control signal to obtain the discrete control signal; and holding the discrete control signal to generate the continuous control signal. Therefore, closed-loop anti-disturbance control is achieved by compensating the predicted signal for disturbance.

In some embodiments, the method comprises: determining disturbance indicator based on the disturbance feature information; wherein the resampling is performed on the disturbance estimation signal by increasing sampling frequency when the disturbance indicator is greater than a predetermined threshold value, and the resampling is performed on the disturbance estimation signal by reducing sampling frequency when the disturbance index is less than the threshold value. Therefore, the disturbance indicators determined based on disturbance feature information can flexibly select multiple types of resampling strategies.

Some embodiments include an electronic device comprising a processor and a memory, wherein an application program executable by the processor is stored in the memory for causing the processor to execute one or more of the methods for controlling servo system as described herein.

Some embodiments include a computer-readable medium comprising computer-readable instructions stored thereon, wherein the computer-readable instructions, when executed by a processor, implement one or more of the methods for controlling servo system as described herein.

Some embodiments include a computer program product comprising a computer program, when the computer program is executed by a processor for executing one or more of the methods for controlling servo system as described herein.

In order to make the purpose, technical scheme and advantages of the present disclosure more clear, the following examples are given to further explain the teachings in detail. In order to be concise and intuitive in description, the schemes are described below by describing several representative embodiments. Many details in the embodiments are only used to help understand. However, it is obvious that the technical scheme herein can be realized without being limited to these details. In order to avoid unnecessarily blurring the disclosure, some embodiments are not described in detail, but only the framework is given. Hereinafter, “including” refers to “including but not limited to”, “according to . . . ” refers to “at least according to . . . , but not limited to . . . ”. Due to the language habits of Chinese, when the number of an element is not specifically indicated below, it means that the element can be one or more or at least one.

Although Model Predictive Controller (MPC) exhibits certain application potential in digital servo control systems due to its model prediction and sliding window real-time optimization characteristics, this trajectory planning servo control framework has at least the following technical issues:
(1): Consider the MPC design under multi rate sampling. Measurement noise or interference in the multi rate sampling process are not taken account in the existed MPC design and optimization.
(2): Consider the digital servo control system design for the multi-axes CNC machine. Although digital MPC can deal with system uncertainties to some extent through sliding window model prediction, high frequency disturbance beyond Nyquist frequency of the system output cannot be well addressed in the present MPC based servo systems with output sampling restrictions.
(3): Consider the multi-dimensional manufacturing tasks of the overall CNC machines. The measurable or estimated disturbances are not considered in the existed trajectory planning, optimization, and generation strategy of the MPC design.

Overall, for current servo systems, although research and testing have attempted to apply MPC control methods to control frameworks, existing multi rate digital MPC control methods have failed to effectively handle multi frequency interference. Moreover, for CNC servo systems, the current multi rate MPC control methods fail to consider robustness to sampling errors in multi rate digital design. Moreover, current trajectory planning methods fail to consider the impact of interference on the planned trajectory, resulting in low trajectory accuracy.

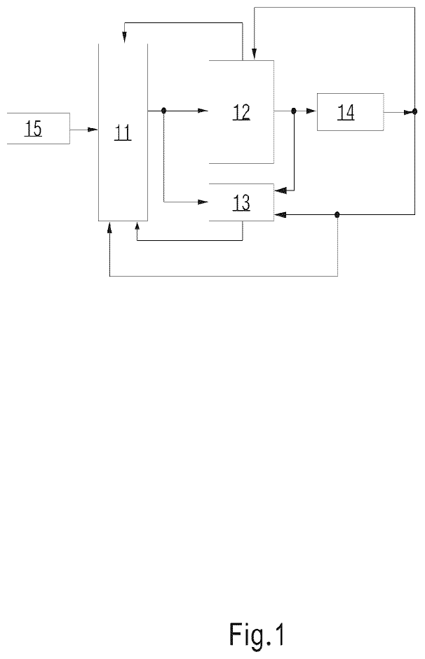

FIG. 1 is a structural diagram of an example system for controlling a servo system incorporating teachings of the present disclosure. As shown in FIG. 1, an example system for controlling servo system, includes:
a reference trajectory generator 11, configured to generate reference trajectory signal of servo system 14 based on manufacturing task instruction for the servo system 14, terminal state prediction signal within a sliding window of the servo system 14, measurement signal of the servo system 14, and disturbance estimation signal of the servo system 14;
a controller 12, configured to generate control signal for controlling the servo system 14 and update the disturbance estimation signal based on the reference trajectory signal and the measurement signal; and
a predictor 13, configured to update the terminal state prediction signal based on the reference trajectory signal, the control signal, and the measurement signal updated due to the execution of the control signal by the servo system 14.

The reference trajectory generator 11 is configured to update the reference trajectory signal based on the manufacturing task instruction, updated terminal state prediction signal, updated measurement signal, and updated disturbance estimation signal. Here, servo system 14 is driven by control signals to perform positioning tasks. Servo system 14 may include: (1) feed servo system, which controls the cutting feed motion of each coordinate axis of the machine tool, mainly in linear motion; (2) Spindle servo system, which controls the cutting motion of the spindle and mainly revolves. Specifically, servo system 14 can be implemented as a servo system for rotating motors, a planar motion servo system (such as a fast knife servo platform), a multi degree of freedom parallel robot, and a multi degree of freedom positioning/scanning instrument, among others.

In some embodiments, the system for controlling servo system comprises: a manufacturing task generator 15, configured to generate the manufacturing task instruction based on user input. For example, manufacturing task instructions can specifically be program instructions for controlling servo system 14 to perform positioning tasks (such as drawing circles or spiral lines, etc.). Users can provide manufacturing task instructions for manufacturing task generator 15 based on human-machine interaction interface.

Specific methods for determining the terminal state prediction signal of servo system 14 within sliding windows are a mature technology in this field, and the implementation methods described above will not be repeated. The terminal state prediction signal of servo system 14 is continuously updated by predictor 13 during the operation of servo system 14. The measurement signals of servo system 14 are usually positioning signals detected by sensors and output by servo system 14 (such as the displacement, velocity, or acceleration of the control object (such as end effector) of servo system 14, etc.). When servo system 14 executes a control signal, the measurement signals of servo system 14 are updated accordingly. The disturbance estimation signal of servo system 14 is an estimation signal for the interference applied to servo system 14, such as vibration amplitude and frequency of the control object (such as the end effector) of servo system 14. The control signal is usually implemented as a driving signal (such as a voltage signal or a current signal) applied to servo actuator in the servo system 14.

When the system for controlling the servo system is started, the terminal state prediction signal, measurement signal, and disturbance estimation signal of servo system 14 have their respective initial values. These initial values are all settable. For example, the initial value of disturbance estimation signal in servo system 14 can be zero; The initial value of the terminal state prediction signal of servo system 14 within sliding window can be zero; The initial value of the measurement signal of servo system 14 can be zero.

Reference trajectory generator 11 generates a reference trajectory signal of servo system 14 based on manufacturing task instruction for servo system 14, terminal state prediction signal within a sliding window of servo system 14, measurement signals of servo system 14, and disturbance estimation signal of servo system 14. Then, the controller 12 generates a control signal for controlling servo system 14 and updates disturbance estimation signal (i.e., updates the specific value of the disturbance estimation signal) based on the reference trajectory signal and the measurement signal. The predictor 13 updates the terminal state prediction signal based on the reference trajectory signal, control signal, and measurement signal updated when the servo system 14 executes the control signal. Then, the reference trajectory generator 11 updates the reference trajectory signal based on manufacturing task instructions, updated terminal state prediction signals, updated measurement signals, and updated disturbance estimation signal. The above process continues to be executed until the manufacturing task instruction is completed.

In summary, in the system shown in FIG. 1, manufacturing task generator 15 generates manufacturing task instructions based on manufacturing requirements; The reference trajectory generator 11 generates spatial reference trajectory signals for servo system 14 based on manufacturing task instructions, estimated terminal states of servo system 14 within sliding windows, measured output signals of servo system 14, and estimated disturbance information. Controller 12 (usually implemented as a digital controller) can generate control signals based on model observers with multi-rate anti-interference observations. Servo system 14 performs positioning tasks based on control signals. The predictor 13 provides a prediction signal for the terminal state of the servo system 14 within sliding window.

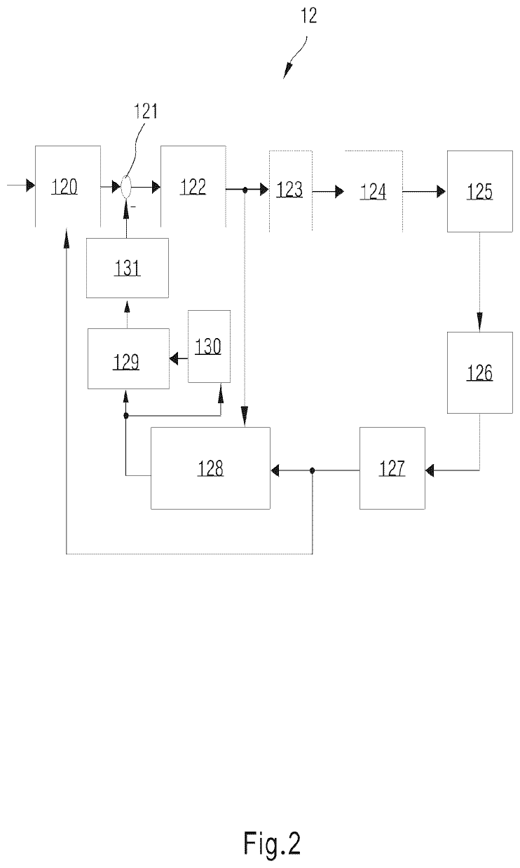

FIG. 2 is an exemplary functional module diagram of an example controller incorporating teachings of the present disclosure. As shown in FIG. 2, the controller 12 comprises: an anti-aliasing filter 125, configured to perform anti-aliasing filtering on the measurement signal obtained by sensor 124; a sampler 126, configured to perform sampling on anti-aliasing filtered measurement signal to obtain discrete measurement signal; an up-sampling processing module 127, configured to perform up-sampling processing on the discrete measurement signal.

The controller 12 further comprises: a digital disturbance observer 128, configured to determine the disturbance estimation signal of the servo system 14 based on discrete measurement signal after the up-sampling processing and continuous control signal of the servo system 14; the continuous control signal is obtained by performing hold processing on a discrete control signal, which is obtained based on discrete MPC control signal and compensation value of the disturbance estimation signal, and the discrete MPC control signal is obtained based on the reference trajectory signal and the discrete measurement signal after the up-sampling processing.

The controller 12 further comprises: a disturbance analyzer 130, configured to determine disturbance feature information based on the disturbance estimation signal; a disturbance resampling module 129, configured to perform resampling on the disturbance estimation signal based on the disturbance feature information; a disturbance compensator 131, configured to determine the compensation value of the disturbance estimation signal based on the resampled disturbance estimation signal.

The controller 12 further comprises: a digital model predictive controller (MPC) 120, configured to determine the discrete MPC control signal based on the reference trajectory signal and the discrete measurement signal after the up-sampling processing; a subtractor 121, configured to subtract the compensation value of the disturbance estimation signal from the discrete MPC control signal to obtain the discrete control signal; a holder 122, configured to hold the discrete control signal to generate the continuous control signal. Servo actuator 123 executes the continuous control signal to drive servo system 14. The measurement signal of servo system 14 obtained by sensor 124 is updated due to the execution of the control signal by the servo actuator 123.

In some embodiments, the disturbance resampling module 129 is configured to determine disturbance indicator based on the disturbance feature information, wherein the resampling is performed on the disturbance estimation signal by increasing sampling frequency when the disturbance indicator is greater than a predetermined threshold value, and the resampling is performed on the disturbance estimation signal by reducing sampling frequency when the disturbance index is less than the threshold value. The servo actuator 123 and sensor 124 in FIG. 2 are usually considered as components of the servo system 14, so they are illustrated in dashed boxes in FIG. 2.

The typical processing process of controller 12 is described below.

Step 1: The digital MPC120 generates discrete MPC control value based on reference trajectory signal generated by reference trajectory generator 11 and discrete measurement signal output by up-sampling processing module 127.

Step 2: The subtractor 121 performs a subtraction operation on the discrete MPC control value and the compensation value of the disturbance estimation signal generated by disturbance compensator 131 to obtain discrete control signal.

Step 3: The discrete control signal is input to holder 122, which performs sampling and holding operations on the discrete control signal to obtain a continuous control signal.

Step 4: The continuous control signal is input to servo actuator 123 in servo system 14, which executes the continuous control signal to perform positioning tasks.

Step 5: Sensor 124 in servo system 14 measures the measurement value output by servo actuator 123 after executing the control signal.

Step 6: The measured values of sensor 124 are processed through an anti-aliasing filter 126 and subjected to anti-aliasing filter processing.

Step 7: The measured value processed by the anti-aliasing filter is sampled by sampler 126 to obtain discrete measurement signal.

Step 8: The discrete measurement signal is subjected to up-sampling processing through the up-sampling processing module 127 to obtain a faster rate discrete measurement signal. The up-sampled discrete measurement signal is provided to the disturbance observer 128 and the digital MPC120 respectively for closed-loop control.

Step 9: The digital disturbance observer 128 calculates the disturbance estimation signal based on the up-sampled discrete measurement signal and continuous control signal.

Step 10: The disturbance analyzer 130 performs statistical analysis on the disturbance estimation signal, obtaining frequency domain and statistical characteristics of the disturbance as disturbance feature information.

Step 11: The disturbance resampling module 129 resamples (down-sampling) the disturbance estimation signal generated by the digital disturbance observer 128 based on the disturbance feature information, obtains the compensation value of the disturbance estimation signal, and provides the compensation value of the disturbance estimation signal to the subtractor 121 for closed-loop anti-interference control.

In summary, the servo actuator 123 is used to be driven to perform positioning tasks. Sensor 124 is used to measure output signals of servo actuator 123. The anti-aliasing filter 125 can be implemented as a low-pass filter that performs anti frequency aliasing. Sampler 126 for sampling the output of anti-aliasing filter 125. The up-sampling processing module 127 is used to increase sampling frequency and perform up-sampling operations on the output of the sampler 126. Digital disturbance observer 128 is used to estimate the disturbance of servo actuator 123 and obtain disturbance estimation signals. Disturbance analyzer 130 is used to statistically analyze disturbance estimation signal, obtain frequency domain and statistical characteristic information of disturbance, and use it as disturbance feature information. Disturbance resampling module 129 is used to determine sampling strategy for disturbance compensation based on disturbance index of disturbance feature information. Disturbance compensator 131 for generating disturbance compensation values. MPC controller 120 is used to implement MPC control strategies and provide feedback control inputs. Holder 122 for converting discrete signals into continuous signals.

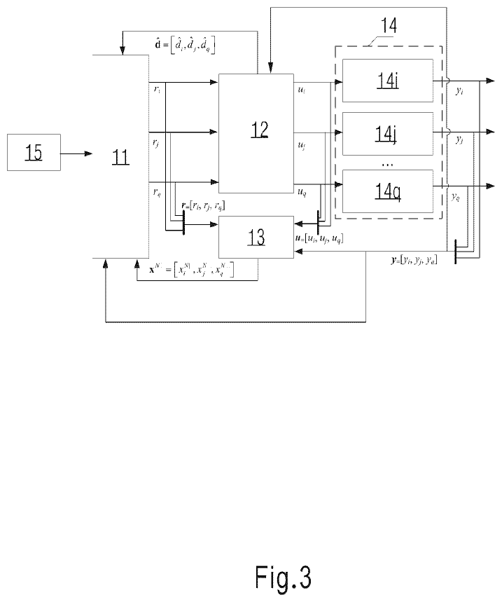

FIG. 3 is a structural diagram of an example control system of a multi axis servo system incorporating teachings of the present disclosure. In FIG. 3, servo system 14 is implemented as a servo system containing multiple axes (14i~14q). Among them, servo system 14 contains an infinite number of axes, which can be more or less, and each axis can be considered as an independent servo system. An MPC via a novel sampled-data signal reconstruction method is designed. In the digital control structure, an anti-aliasing filter is designed as an analog device to make the feedback system to be L2-bounded.

Equation group (1) is the design function of the servo system for each axis 14i~14q:

$$\{ \begin{matrix}\dot{x} = Ax + B u + E d \\ y = C x + R r\end{matrix} \qquad ( 1 )$$

Where: x is the system state of each axis; u is the control input for each axis; d is the equivalent total interference suffered by the system of each axis; y is the system output for each axis; A, B, C, E, R are system state space matrices for each axis.

Propose an optimization index function J for overall MPC control.

Among them:

$$J = {min}_{{U}_{t}} {\underbrace{{α}_{1} {G}_{1} ( {x}_{N \vert t} , {r}_{N \vert t} ) + {α}_{2} {\sum }_{m = 0}^{N - 1} {G}_{2} ( {x}_{m \vert t} , {r}_{m \vert t} , {u}_{m \vert t} )}}_{{J}_{1}} + {\underbrace{{α}_{3} {‖ ( {e}^{- lhs} - {PH}_{h} {K}_{MPC} {S}_{h} {F}_{c} ) {W}_{c 1} ‖}_{∞}}}_{{J}_{2}} \qquad ( 2 )$$

$$s . t . {x}_{t + 1 \vert t} = {A}_{d} {x}_{m \vert t} + {B}_{d} {u}_{m \vert t} \qquad ( 3 a )$$

$${u}_{min} \leq {u}_{m \vert t} \leq {u}_{max} \qquad ( 3 b )$$

$${x}_{min} \leq {x}_{m \vert t} \leq {x}_{max} \qquad ( 3 c )$$

$${y}_{min} \leq {C}_{d} {x}_{m \vert t} + {R}_{d} {r}_{m \vert t} \leq {y}_{max} \qquad ( 3 d )$$

$${‖ ( {e}^{- mhs} - {PH}_{h} {KS}_{h} {F}_{c} ) {W}_{c 1} ‖}_{∞} < {γ}_{set} \qquad ( 3 e )$$

$${x}_{0} , {u}_{0} \qquad ( 3 f )$$

Equations (3a)-(3f) are constraints for MPC optimization.

Among them: J is the optimization index function designed by MPC, α₁, α₂ and α₃ are optional parameters; x_{N|t} is the N-step prediction state at time t; r_{N|t} is the predicted value of the N-step reference signal at time t; x_{m|t} is the m-step predicted state at time t; r_{m|t} is the predicted value of the m-step reference signal at time t; u_{m|t} is the predicted value of the m-step system control input at time t; x_{t+1|t} is the 1-step predicted state at time t; e^{-lhs} is an ideal channel model with a lag value of lh; P is the servo system matrix; Hₕ is the holder matrix; Sₕ is the sampler matrix; F_{c} is the designed filter matrix; W_{c1} is the H∞ weight matrix; x₀ is the initial value of the system state; u₀ is the initial value of the control input; A_{d}, B_{d} are ideal system matrixes; ∥·∥_{∞} is L_{∞} norm; uₜ is the control input value to be optimized; uₘᵢₙ and uₘₐₓ are the minimum and maximum limits of the control input values, respectively; xₘᵢₙ and xₘₐₓ are the minimum and maximum limits of the input values for the servo system state, respectively; γₛₑₜ is a preset sampling optimization threshold; N is the predicted range; G₁(x_{N|t},r_{N|t}) is a function of x_{N|t} and r_{N|t}, where G₁(x_{N|t},r_{N|t}) is greater than or equal to zero; G₂(x_{m|t}, r_{m|t}, u_{m|t}) is a function of x_{m|t} and r_{m|t}, and u_{m|t} G₂(x_{m|t},r_{m|t},u_{m|t}) is greater than or equal to zero.

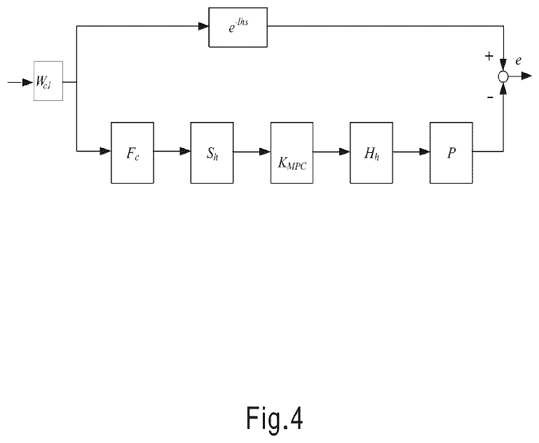

FIG. 4 is a schematic diagram of processing the measurement noise problem in a multi rate sampling framework incorporating teachings of the present disclosure. As shown in FIG. 4, J2 and constraints (such as equation (3e)) were introduced in MPC design to address the measurement noise impact problem in multi rate sampling frameworks through H^{∞} optimization.

Some embodiments include a multi rate interference observer for estimating and compensating the equivalent lumped interference d of a servo system as shown in equation group (1). For the servo system shown in equation group (1), the design of the disturbance observer is as follows:

$$\hat{\overline{x}} [ k + 1 ] = F ( \hat{\overline{x}} [ k ] , \hat{\overline{x}} [ k , 1 ] , … , \hat{\overline{x}} [ k , h - 1 ] , u [ k ] ) + Γ ( y [ k ] - C \hat{\overline{x}} [ k ] ) \hat{d} [ k + 1 ] = {[ 0 … 1 ]}^{T} \hat{\overline{x}} [ k + 1 ] \qquad ( 4 )$$

Where: k is the discrete sampling time; x̅[k]=[x₁[k], . . . , xₙ[k],d]^{T} is the discrete extended state of the servo system as shown in equation group (1); x[k,1] . . . , x[k,h−1] represents the first state to h−1 state between the sampling points in the discrete states x[k] and x[k+1], respectively; \overline{\hat{z}}[k] is the estimated state of the discrete expansion state x̅[k]; F(□) is a function; Γ is the observation gain function; [k+1] is the estimated interference value for the k+1 sampling time.

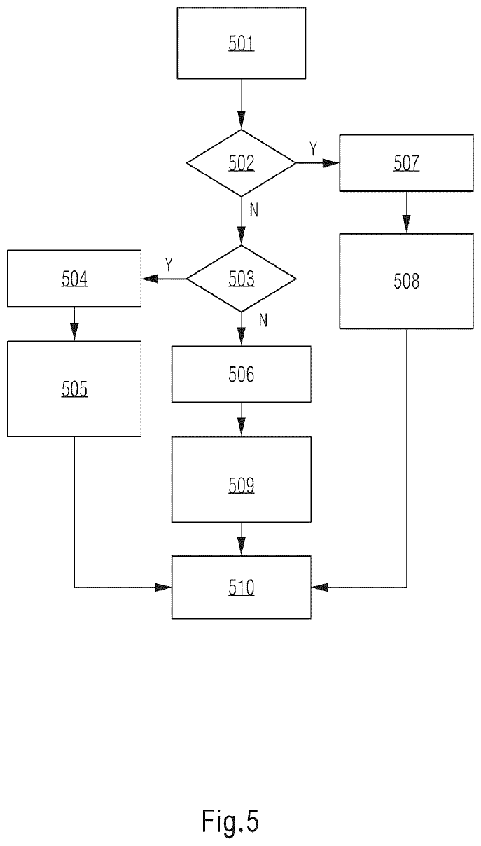

In order to improve the interference suppression ability of multi frequency bands (especially Nyquist frequency external interference), the implementation method of the present invention also proposes an interference analyzer and resampling settings. FIG. 5 is a schematic diagram of interference analysis and sampling strategy according to the embodiment of the present invention. As shown in FIG. 5, interference analysis and sampling strategies specifically include:

Step 501: Determine disturbance indicator based on disturbance estimation signals for disturbance feature information. For example, counting current disturbance estimation signal and predetermined number of disturbance estimation signals in history to determine disturbance feature information and disturbance indicator. For example, disturbance feature information can be frequency characteristics of all disturbance estimation signals (that is, current disturbance estimation signal and predetermined number of disturbance estimation signals in history). Overall, the larger the frequency of disturbance estimation signals represented by disturbance feature information, the larger the disturbance index. For example, first, calculate the sum of squares of the frequency eigenvalues of all disturbance estimation signals that have been statistically calculated; Then determine the square root of the sum of squares as the disturbance indicator.

Step 502: Determine whether the disturbance indicator is greater than a pre-set threshold value. If it is (corresponding to the “Y” branch), execute step 507 and its subsequent steps; if it is not (corresponding to the “N” branch), execute step 503 and its subsequent steps.

Step 503: Determine if the disturbance indicator is less than the threshold value. If it is (corresponding to the “Y” branch), execute step 504 and its subsequent steps; if it is not (corresponding to the “N” branch), execute step 506 and its subsequent steps.

Step 504: Determine the execution of down-sampling strategy.

Step 505: During the execution of the down-sampling strategy, calculate updated sampling period of the disturbance compensator and skip to step 510. Among them, when the disturbance index is smaller, the updated sampling period has more added value compared to the current sampling period.

Step 506: Determine and execute normal sampling strategy, and skip to step 509.

Step 507: Determine the execution of up-sampling strategy.

Step 508: During the execution of the up-sampling strategy, calculate updated sampling period of the disturbance compensator and skip to step 510. Among them, the larger the disturbance index, the smaller the reduction value of the updated sampling period compared to the current sampling period.

Step 509: In normal sampling strategy, keep the sampling period of the disturbance compensator unchanged. That is, the updated sampling period is equal to the current sampling period.

Step 510: update sampling period of the disturbance compensator, by the updated sampling period.

Specifically, the disturbance compensator design is as follows:

$${u}_{d} = \{ \begin{matrix}\begin{matrix}{ζ}_{1} ( \hat{d} [ k ] , \hat{d} [ k - 1 ] , … , \hat{d} [ k - n ] ) , up - sampling \\ {ζ}_{2} ( \hat{d} [ k ] , \hat{d} [ k - 1 ] , … , \hat{d} [ k - n ] ) , normal sampling\end{matrix} \\ {ζ}_{3} ( \hat{d} [ k ] , \hat{d} [ k - 1 ] , … , \hat{d} [ k - n ] ) , down - sampling\end{matrix}$$

Among them: u_{d} is the system interference compensation value after resampling. ζ₁(·), ζ₂(·), ζ₃(·) are calculation functions of system disturbance compensation values for increasing the sampling frequency (up-sampling strategy), keeping the sampling frequency constant (normal sampling strategy), and decreasing the sampling frequency (down-sampling strategy), respectively.

Some embodiments include an improved reference trajectory generator for generating reference trajectory signals for the servo system, in which interference information is introduced into the reference trajectory generator to avoid the negative impact of some risk paths verified in previous motion on trajectory planning.

Specifically, the design of the reference trajectory generator is:

$${max}_{r ( t )} {J}_{r} = \overline{ω} ( {r}_{history} , {x}_{prediction} , \hat{x} , u , \hat{d} , σ ( r ) ) \qquad ( 6 )$$

$$s . t . {x}_{prediction} ∈ O \{ {x}_{prediction} \} \qquad ( 6 a )$$

$${r}_{history} ∈ Π \{ {r}_{history} \} \qquad ( 6 b )$$

$${u}_{min} \leq {u}_{m \vert t} \leq {u}_{max} \qquad ( 6 c )$$

$${\hat{x}}_{min} \leq \hat{x} \leq {\hat{x}}_{max} \qquad ( 6 d )$$

$${y}_{min} \leq {C}_{d} {x}_{m \vert t} + {R}_{d} {r}_{m \vert t} \leq {y}_{max} \qquad ( 6 e )$$

$${r}_{min} \leq r ( t ) \leq {r}_{max} \qquad ( 6 f )$$

Among them, Jᵣ is the optimization index function generated by the trajectory; ω(·) is the trajectory generation function; r_{history} is the historical value of the servo system trajectory reference signal; x_{prediction} is the predicted state of the system based on the predictor; \hat{x} is estimated state of the system; u is the control input value; \hat{d} is the estimated value of system interference; σ(r) is prediction function for the trajectory reference signal; rₘᵢₙ and rₘₐₓ, are the minimum and maximum limits for estimation reference signal, respectively; O{x_{prediction}} is the restricted set of system prediction states for the predictor; Π{r_{history}} is the restricted set of servo system trajectory reference signals.

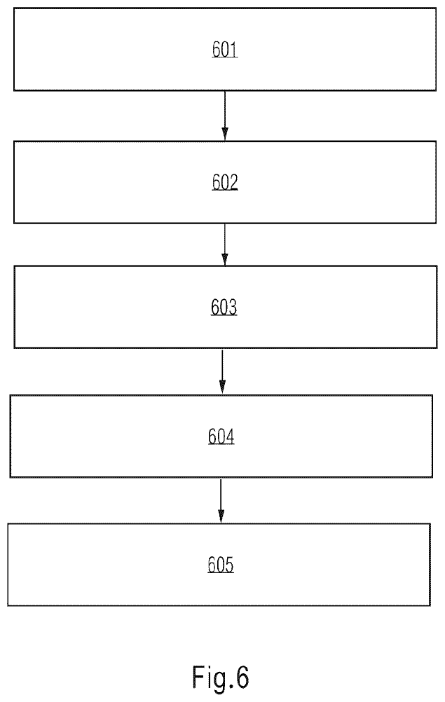

FIG. 6 is a flowchart of an example method for controlling a servo system incorporating teachings of the present disclosure. As shown in FIG. 6, the method comprises:

Step 601: generating reference trajectory signal of servo system based on manufacturing task instruction for the servo system, terminal state prediction signal within a sliding window of the servo system, measurement signal of the servo system, and disturbance estimation signal of the servo system.

Step 602: generating control signal for controlling the servo system based on the reference trajectory signal and the measurement signal.

Step 603: updating the disturbance estimation signal based on the reference trajectory signal and the measurement signal.

Step 604: updating the terminal state prediction signal based on the reference trajectory signal, the control signal, and the measurement signal updated due to the execution of the control signal by the servo system. and

Step 605: updating the reference trajectory signal based on the manufacturing task instruction, updated terminal state prediction signal, updated measurement signal, and updated disturbance estimation signal.

In one embodiment, the method comprising: generating the manufacturing task instruction based on user input.

In some embodiments, the method includes: performing anti-aliasing filtering on the measurement signal; performing sampling on filtered measurement signal to obtain discrete measurement signal; performing up-sampling processing on the discrete measurement signal.

In some embodiments, the method includes: determining the disturbance estimation signal of the servo system based on discrete measurement signal after the up-sampling processing and continuous control signal of the servo system; wherein the continuous control signal is obtained by performing hold processing on a discrete control signal, which is obtained based on discrete MPC control signal and compensation value of the disturbance estimation signal, and the discrete MPC control signal is obtained based on the reference trajectory signal and the discrete measurement signal after the up-sampling processing.

In some embodiments, the method includes: determining disturbance feature information based on the disturbance estimation signal; performing resampling on the disturbance estimation signal based on the disturbance feature information; determining the compensation value of the disturbance estimation signal based on the resampled disturbance estimation signal.

In some embodiments, the method includes: determining the discrete MPC control signal based on the reference trajectory signal and the discrete measurement signal after the up-sampling processing; subtracting the compensation value of the disturbance estimation signal from the discrete MPC control signal to obtain the discrete control signal; holding the discrete control signal to generate the continuous control signal.

In some embodiments, the method includes: determining disturbance indicator based on the disturbance feature information; wherein the resampling is performed on the disturbance estimation signal by increasing sampling frequency when the disturbance indicator is greater than a predetermined threshold value, and the resampling is performed on the disturbance estimation signal by reducing sampling frequency when the disturbance index is less than the threshold value.

Some embodiments include a multi rate MPC digital control method in a CNC servo system and introduce estimation information of interference into the trajectory planning of CNC servo system, avoiding partial trajectory strategies through interference characteristics. Some embodiments include a multi rate interference observation compensator, where the resampling period of interference compensation can be automatically selected and set based on the interference characteristics. Moreover, the measured output signal of the system entering the MPC digital controller is improved in robustness to noise through anti-aliasing analog filters and H∞ optimization. In addition, this multi rate digital control framework is not only applicable to servo systems for rotating motors, but also in the design of servo control systems for planar motion servo systems (such as fast knife servo platforms), multi degree of freedom parallel robots, and multi degree of freedom positioning/scanning instruments.

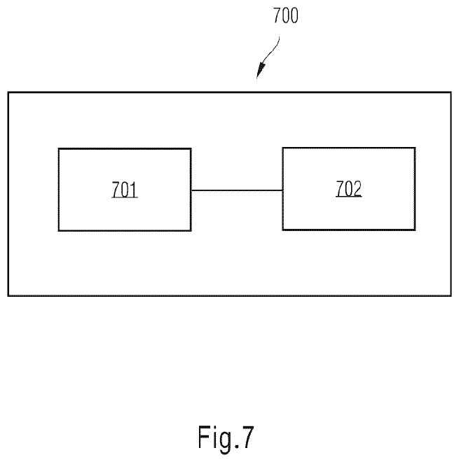

Some embodiments include an electronic device with processor-memory architecture. FIG. 7 is a structural diagram of an electronic device incorporating teachings of the present disclosure. As shown in FIG. 7, the electronic device 700 comprises a processor 701, a memory 702, and a computer program stored in the memory 702 and executable on the processor 701. When the computer program is executed by the processor 701, any one of the above-mentioned methods for controlling a servo system is implemented.

The memory 702 may specifically be implemented as various storage medium such as Electrically Erasable Programmable Read-Only Memory (EEPROM), Flash memory (Flash memory), Programmable Program Read-Only Memory (PROM). The processor 701 may be implemented to include one or more central processing units or one or more field programmable gate arrays, wherein the field programmable gate arrays integrate one or more central processing unit cores. Specifically, the central processing unit or central processing unit core may be implemented as a CPU or MCU or DSP, and so on.

It should be noted that not all steps and modules in the above-mentioned processes and structural diagrams are necessary, and some steps or modules may be omitted according to actual needs. The execution logic of each step is not fixed and can be adjusted as needed. The division of each module is only to facilitate the description of the functional division used. In actual implementation, a module can be implemented by multiple modules, and the functions of multiple modules can also be implemented by the same module. These modules can be in the same device or in a different device.

The hardware modules in various embodiments may be implemented mechanically or electronically. For example, a hardware module may include specially designed permanent circuits or logic devices (e.g., special-purpose processors, such as FPGAs or ASICs) to perform specific operations. Hardware modules may also include programmable logic devices or circuits temporarily configured by software (e.g., including general-purpose processors or other programmable processors) for performing operations. As for the specific mechanical method, or a dedicated permanent circuit, or a temporarily configured circuit (e.g., configured by software) to realize the hardware module, it can be decided according to cost and time considerations.

The above descriptions are merely example embodiments of the teachings of the present disclosure and are not intended to limit the protection scope thereof. Any modification, equivalent replacement, improvement, etc. made within the spirit and principle of the present disclosure shall be included within the protection scope thereof.

What is claimed is:

1. A system for controlling a servo system, the system comprising:
a reference trajectory generator to generate a reference trajectory signal of the servo system based on manufacturing task instructions for the servo system, a terminal state prediction signal within a sliding window of the servo system, a measurement signal of the servo system, and a disturbance estimation signal of the servo system;
a controller to generate control signal for controlling the servo system and update the disturbance estimation signal based on the reference trajectory signal and the measurement signal; and
a predictor to update the terminal state prediction signal based on the reference trajectory signal, the control signal, and the measurement signal updated due to the execution of the control signal by the servo system;
wherein the reference trajectory generator updates the reference trajectory signal based on the manufacturing task instruction, updated terminal state prediction signal, updated measurement signal, and updated disturbance estimation signal.

2. The system of claim 1, further comprising a manufacturing task generator to generate the manufacturing task instruction based on user input.

3. The system of claim 1, wherein the controller comprises:
an anti-aliasing filter to perform anti-aliasing filtering on the measurement signal;
a sampler to perform sampling on anti-aliasing filtered measurement signal to obtain discrete measurement signal; and
an up-sampling processing module to perform up-sampling processing on the discrete measurement signal.

4. The system of claim 3, wherein the controller comprises:
a digital disturbance observer to determine the disturbance estimation signal of the servo system based on discrete measurement signal after the up-sampling processing and continuous control signal of the servo system;
wherein the continuous control signal is obtained by performing hold processing on a discrete control signal obtained based on discrete MPC control signal and compensation value of the disturbance estimation signal, and the discrete MPC control signal obtained based on the reference trajectory signal and the discrete measurement signal after the up-sampling processing.

5. The system of claim 4, wherein the controller comprises:
a disturbance analyzer to determine disturbance feature information based on the disturbance estimation signal;
a disturbance resampling module to perform resampling on the disturbance estimation signal based on the disturbance feature information; and
a disturbance compensator to determine the compensation value of the disturbance estimation signal based on the resampled disturbance estimation signal.

6. The system of claim 5, wherein the controller comprises:
a digital model predictive controller to determine the discrete MPC control signal based on the reference trajectory signal and the discrete measurement signal after the up-sampling processing;
a subtractor to subtract the compensation value of the disturbance estimation signal from the discrete MPC control signal to obtain the discrete control signal; and
a holder to hold the discrete control signal to generate the continuous control signal.

7. The system of claim 5, wherein;
the disturbance resampling module determines the disturbance indicator based on the disturbance feature information;
the resampling is performed on the disturbance estimation signal by increasing sampling frequency when the disturbance indicator is greater than a predetermined threshold value; and
the resampling is performed on the disturbance estimation signal by reducing sampling frequency when the disturbance index is less than the threshold value.

8. A method for controlling a servo system, the method comprising:
generating a reference trajectory signal of the servo system based on manufacturing task instruction for the servo system, a terminal state prediction signal within a sliding window of the servo system, a measurement signal of the servo system, and a disturbance estimation signal of the servo system;
generating a control signal for controlling the servo system based on the reference trajectory signal and the measurement signal;
updating the disturbance estimation signal based on the reference trajectory signal and the measurement signal;
updating the terminal state prediction signal based on the reference trajectory signal, the control signal, and the measurement signal updated due to the execution of the control signal by the servo system; and
updating the reference trajectory signal based on the manufacturing task instruction, updated terminal state prediction signal, updated measurement signal, and updated disturbance estimation signal.

9. The method of claim 8, further comprising generating the manufacturing task instruction based on user input.

10. The method of claim 8, further comprising:
performing anti-aliasing filtering on the measurement signal;
performing sampling on an anti-aliasing filtered measurement signal to obtain discrete measurement signal; and
performing up-sampling processing on the discrete measurement signal.

11. The method of claim 10, further comprising:
determining the disturbance estimation signal of the servo system based on discrete measurement signal after the up-sampling processing and continuous control signal of the servo system;
wherein the continuous control signal is obtained by performing hold processing on a discrete control signal, which is obtained based on discrete MPC control signal and compensation value of the disturbance estimation signal, and the discrete MPC control signal is obtained based on the reference trajectory signal and the discrete measurement signal after the up-sampling processing.

12. The method of claim 11, further comprising:
determining disturbance feature information based on the disturbance estimation signal;
performing resampling on the disturbance estimation signal based on the disturbance feature information; and
determining the compensation value of the disturbance estimation signal based on the resampled disturbance estimation signal.

13. The method of claim 12, further comprising:
determining the discrete MPC control signal based on the reference trajectory signal and the discrete measurement signal after the up-sampling processing;
subtracting the compensation value of the disturbance estimation signal from the discrete MPC control signal to obtain the discrete control signal;
holding the discrete control signal to generate the continuous control signal.

14. The method of claim 12, further comprising:
determining disturbance indicator based on the disturbance feature information;
wherein the resampling is performed on the disturbance estimation signal by increasing sampling frequency when the disturbance indicator is greater than a predetermined threshold value, and the resampling is performed on the disturbance estimation signal by reducing sampling frequency when the disturbance index is less than the threshold value.

15-17. (canceled)
